(19) United States
(12) Patent Application Publication
(10) Pub. No.: US 2004/0073484 A1
(43) Pub. Date: Apr. 15, 2004

(54) Electronic display advertising method and apparatus

(76) Inventors: Marc Camporeale, New York City, NY (US); Kiho Shin, New York City, NY (US)

Correspondence Address: KAPLAN & GILMAN , L.L.P., 900 ROUTE 9 NORTH, WOODBRIDGE, NJ, 07095, US

(21) Appl. No.: 10/408,702

(22) Filed: Apr. 7, 2003

Related U.S. Application Data
(60) Provisional application No. 60/370,287, filed on Apr. 6, 2002.

(51) Int. Cl. G06F 17/60

(52) U.S. Cl. 705/14

(57) ABSTRACT

A system for electronic display advertising is provided in which advertisers are presented with advertising venues for automated display of selected advertisements. Advertisements are inspected for content acceptability. The advertisements are established as web page static or active displays that are stored in and transmitted from a server. The advertiser selects venues and times for advertising display. Proceeds from advertisers are divided between the system operator and the display venue-providing entity.

This application claims the benefit and is a conversion of U.S. Provisional Patent Application No. 60/370,287 filed Apr. 6, 2002.

### FIELD OF THE INVENTION

The present invention relates to the field of advertising of products in retail stores, and more particularly to a system whereby advertisers send an electronic network-based advertisement to a selected advertising venue for a selected time period, in or near the location where the advertised product is being offered for sale.

### BACKGROUND OF THE INVENTION

The broad field of retail promotion advertising has gone through many changes from the time of posting a printed flyer inside a store window to the contemporary development of elaborate displays that are situated in the middle of a store's floor space and are designed to stimulate interest and unplanned purchases of the product being promoted. Retail promotion advertising, is defined as advertising that is geared to drive customers to a particular retail establishment, also known as a public retailing venue, in order to consummate the purchase and/or is placed at the point of purchase to assure that the chosen product is kept foremost in the consumer's mind. This medium relies on a mixture of media delivered both outside and inside the retail environment. Examples of media that are delivered outside the retail environment are: free standing inserts in Sunday newspapers, local television and radio advertising, outdoor advertising on billboards. Examples of media that are delivered inside the retail environment are: paper posters placed in the windows of stores, examples of products on sale placed in the windows of stores, elaborate point-of-purchase displays that stand in the middle of stores' floor space, highlighting the promoted product. In recent years, retailers have, in an attempt to enhance the shopper's in-store experience and induce greater browsing time and incremental sales, implemented electronic media such as in-store radio and television networks, delivered by various media. These networks provide advertising messages to browsing shoppers, with the goal of having them stop, pay attention to the message and buy where they may not have without the signage.

While these new in-store networks are utilizing digital media to effect sales increases, they are essentially modifications of the established, centralized model of broadcast and cable TV and radio networks. In this model Content must be produced in a very specific format. The advertiser submits a desired plan to a human representative of the medium, and the human representative sets about fashioning the content and the general stated desires into a media schedule, format and editorial environment that seems to satisfy the advertiser's objectives. In this model, the advertiser is always at the mercy of the human planner to see that the desired schedule is implemented. Accordingly, the specifics of exactly how the schedule is implemented with regard to which actual time slots that carry the advertiser's messages is ultimately controlled by the human contact at the medium and not the advertiser. It would thus be advantageous to create an advertising system which allows the advertiser to control programmed advertising parameters such as time and place of the running of the advertisement based on the availability of time inventory as administered by a centralized time slot reservation database and software application for these retail promotion advertising systems. The innovation that this delivers to the advertiser is an unprecedented degree of control and ability to target specific locations based on data that is made freely available to subscribers to the system.

It would be an additional advantage of such a system to allow the advertiser to create content that can span from the exceedingly simple, such as a static html page, to the highly complex, such as a streamed TV commercial. This permits a range of flexibility for the advertiser and unprecedented control over production time, cost and richness of media, so all can be optimized to meet the requirements of each specific advertising campaign.

Hence, the present invention recognizes that it would be commercially beneficial to display electronically generated advertising in the advertiser's selected public retail venues using a system that allows the advertisers to directly control the time allocation and format of medium that they are choosing to run in those venues.

Therefore, it is an object of the present invention to provide computer generated advertising at public retailing venues that allows advertisers to directly control the time allocation that they are choosing to run in those venues.

It is a further object of the present invention to provide computer generated advertising to be displayed through computer display devices that allow advertisers the broad range of production options that are allowed by standardizing such a system around common web browser-compatible media.

It is a further object of the present invention to provide computer generated advertising to be displayed through computer display devices that are capable of responding to the unique demands of such a user-controlled system.

It is an additional object of the present invention to provide computer generated advertising through a network of retail stores that taken as a group, present a unique opportunity for advertisers who may market products across numerous retail channels, to accomplish retail promotion advertising across all viable channels, using a single resource.

These and other objects will become more apparent from the description of the invention to follow.

### SUMMARY OF THE INVENTION

The present invention provides a system for electronic display advertising in various public retailing venues. A number of display advertising venues are established and appropriate large size display equipment is set up and tested for reliability. Display equipment involves a computer for receiving and processing a signal and a display unit, such as a monitor, a television, or a screen and projector. A system operator contacts potential display venue owners and establishes a listing of venues and times for advertising as well as information regarding venue vicinity traffic. A number of advertisers select advertising venues and times and provide advertisements in the form of static or URL based website content to a server. The system operator inspects all new and revised advertisements for compliance with established rules. Approved advertisements are stored at a server that is controlled by the advertiser or by the system operator and is in electronic communication through a network with advertisers and with venues.

Selected advertisements are displayed at the selected times and venues.

### BRIEF DESCRIPTION OF THE DRAWINGS

FIG. 1 is a schematic representation of a computerized advertising network.

FIG. 2 is a flowchart depicting a process by which an advertising venue becomes available to electronic advertising.

FIG. 3 is a flowchart depicting a process by which an advertiser obtains access to the system, selects advertising venues and times, assigns content to run in those venues and times and transmits advertising to a server.

FIGS. 3(a) through (f) provide enhanced detail on the functionality described in FIG. 3.

FIG. 4 is a flow chart that portrays the Icycle of software and hardware activity and interaction that occurs between the advertising venue display unit(s), the online scheduling and content assignment system, and the server(s) that store(s) the content ultimately destined to play on the display units. This cycle portrays the steps which the machinery implements in order to deliver the desired result of playing the correct content on the correct display unit at the correct time.

FIG. 5 is an exemplary advertising time and venue utilization chart.

### DETAILED DESCRIPTION OF THE INVENTION

A public advertising venue is, according to the preferred embodiment, a retail store that has a window or other section of vertical real estate that faces out onto pedestrian traffic entering or passing by the venue. Some examples of appropriate display advertising venues for the present invention include stores located in shopping centers, stores in shopping malls, “big box” stand-alone stores, stores on city or town streets or avenues. The present invention provides a method and apparatus for utilizing these and other public retailing venues for the display of electronically generated advertisements.

In order for an advertising venue to receive and display electronic advertising, the venue needs a connection link to a network and a display unit. Such a connection must also have a computer and at least one display screen connected to the link. If the venue is large, the display screen may be large, possibly using projection techniques. Alternatively, screen images can be produced by a digital film projector connected to a basic computer. Screens up to as large as 60 feet between opposing diagonal corners are available under current technology. The projection process is operable as a front lit or rear lit system. If such display equipment is used in an outdoor venue, a weather-protective housing, or cover, is needed. A standard building or a polymer cover is considered satisfactory.

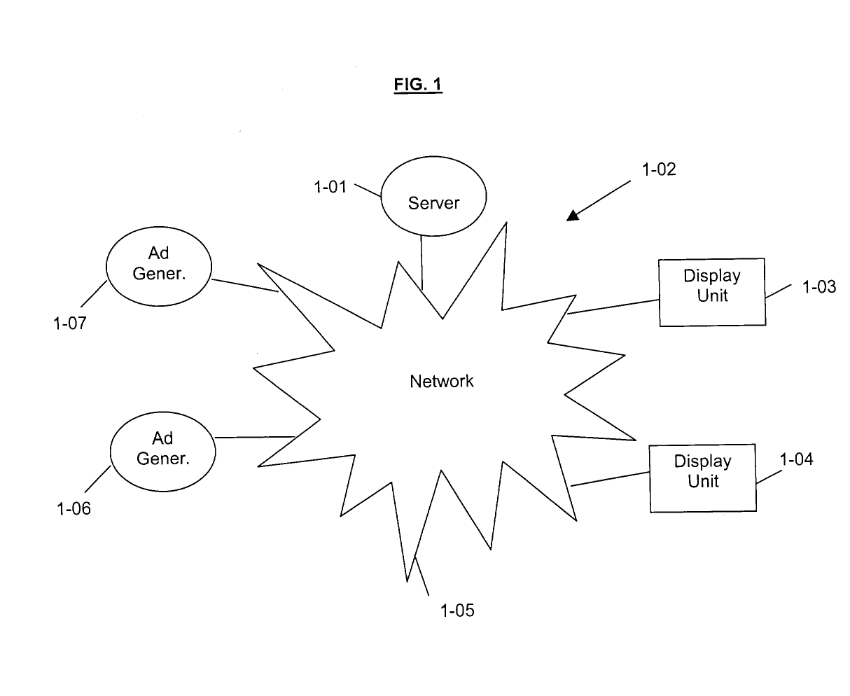

FIG. 1 illustrates schematically a display advertising system 1-02 wherein a plurality of advertising generators 1-07 and 1-06 and a plurality of display units 1-03 and 1-04 are connected by a network 1-05, for example the Internet. An advertising generator such as identified by numbers 1-07 and 1-06 is an individual or entity that creates and submits advertising for display. A display unit such as identified by numbers 1-03 and 1-04 is a receiving and processing computer with an associated apparatus for displaying images, for example a monitor and/or a projector and screen for viewing. Although the example illustrated and described herein shows two advertising generators and two display units, this distribution is presented by way of an example and is not to be judged a limitation on the scope of the invention. Variation in the number of advertising generators and display units, including having a different of one compared to the other, is clearly contemplated. It is also contemplated that multiple display units may be located at one venue.

As will be described below, each of advertising generators 1-07 and 1-06, after agreeing to be a participant in display advertising system 1-02, creates one or more advertisements which are submitted for approval, and are then sent to various advertising venues at selected times. The selected venues, while typically chosen by the participant advertising generator, does not need to be so chosen, and instead, the system operator may make the venue selections (possibly by some criteria specified by the participant).

A server 1-01 is also connected to network 1-05 and acts as a storage medium and connective focus to receive advertisements from advertising generators 1-07, 1-06 and provides such advertisements to advertising venue display units 1-03, 1-04. This server 1-01, may be a server or servers, owned and administered by the system operator, or may be representative of server(s) that each advertiser owns or otherwise controls for the purpose of storing and serving its own ads. Advertisements can vary between static HTML displays, animated displays, and/or are linked to live URLs. Obviously, all such displays can include audio.

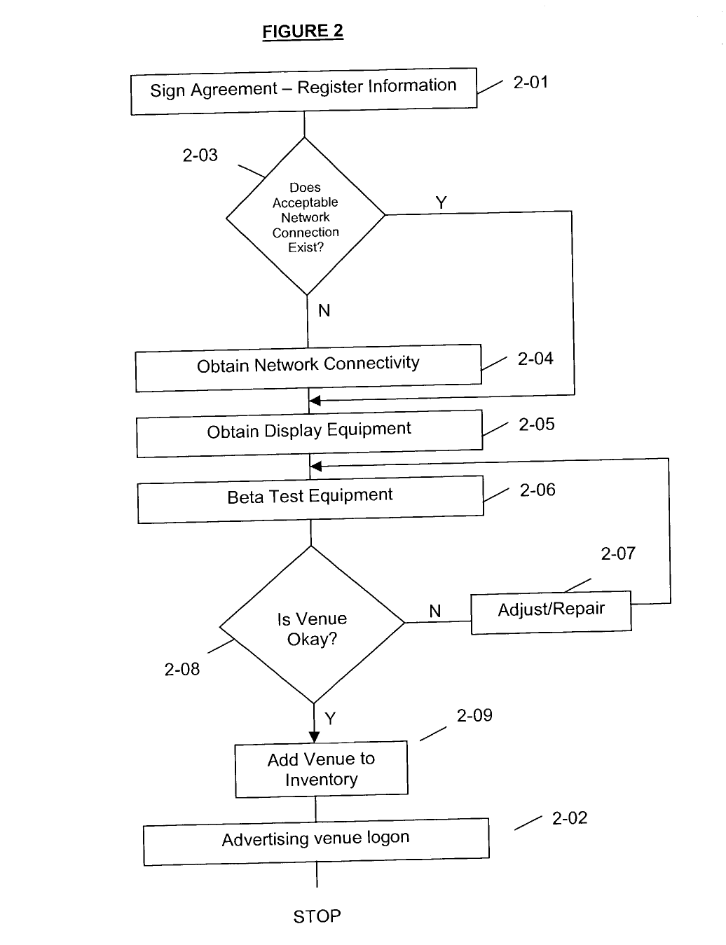

Referring now to FIG. 2, the process by which an advertising venue is brought into the system is described. An advertising venue provider is evaluated and approved for inclusion in the network. Once approved, the advertising venue provider signs an agreement, 2-01, and gives the system operator a range of information that is pertinent to the effective implementation of the system, for example, entity identification, type of venue (drugstore, supermarket etc.), type and size of display area where the display units will be used, etc. The venue provision agreement is customized to take into account the current status of the advertising venue with respect to computer and display equipment and network access availability. A determination is made in step 2-03 whether an acceptable level of network connection, i.e. speed and bandwidth, presently exists in the venue. If yes, step 2-04 is passed over. If no, the venue providing entity obtains an acceptable level of network connectivity in step 2-04 or may be provided one by the system operator. Thereafter, the venue owner rents or purchases computer reception and display equipment at step 2-05, or the system operator may elect to provide the equipment, installation and servicing of same at its cost.

Once the connectability is established and the equipment is available, a beta test program is begun in step 2-06 to verify the efficacy of the system. A beta test refers to a test of the connection quality and the receiving and displaying equipment by use of a “dummy” advertisement for performance evaluation. A determination is made in step 2-08 as to whether the venue is ready for displaying advertisements. If yes, the venue is added in step 2-09 to a list of venue inventory that is made available to advertisers, and the system stops. If no necessary repairs or adjustments are made in step 2-07 and the system recycles to step 2-06 to redo the beta test. The system operator additionally trains individuals in the advertising venues to operate the equipment so as to be able to more efficiently correct faults. Once all has been tested, in step 2-02 the venue operator is provided with an account, password and access to log-on to the system.

The present invention also anticipates that any one venue may have multiple display units. In such a case, the preferred embodiment is for all of the display units to show the same advertisements at the same time. However, this does not have to be the case, and, for example, multiple advertisements can run on different monitors at different times; although in such cases, provision will preferably be made to not allow the venue to run display units too close to each other, so as to avoid a competitive viewing atmosphere amongst paying advertisers. Further, for large venues (i.e., multi-level or multi-department stores, or stores having many street level window displays, or sports arenas having many different types of vendor stands, such as food and gift stands), the system operator may list the venue as two or more venues, so as to allow for the running of different advertisements at different locations of the venue at the same time.

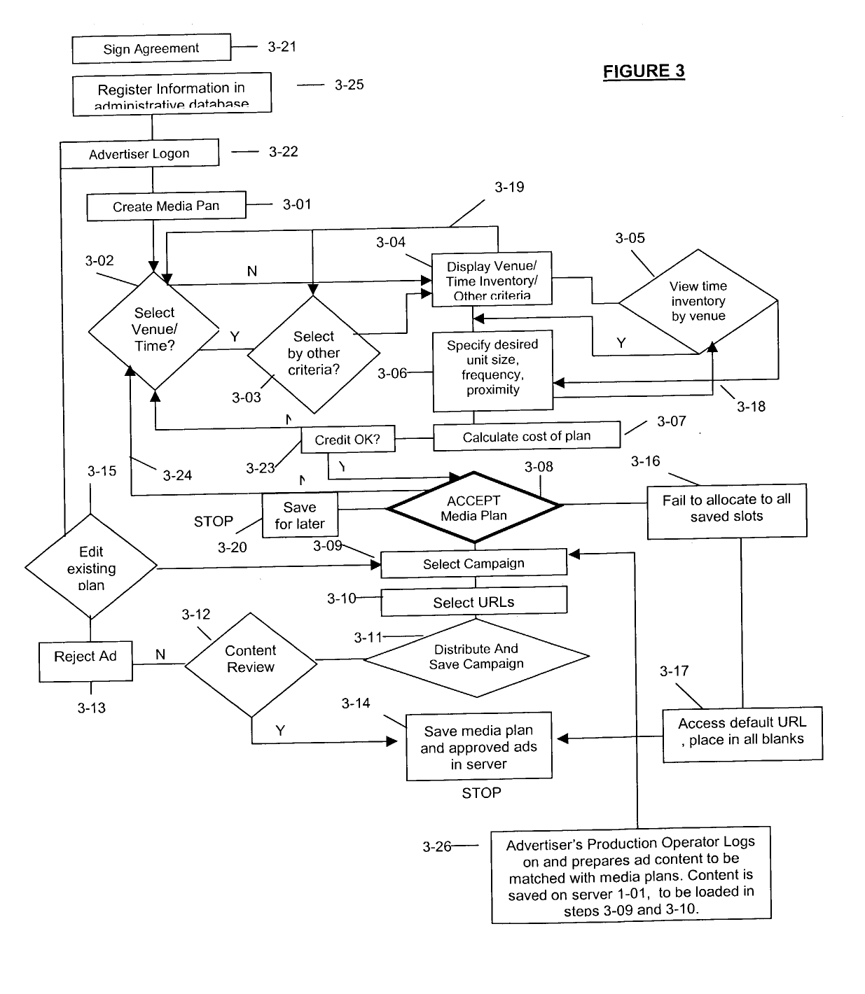

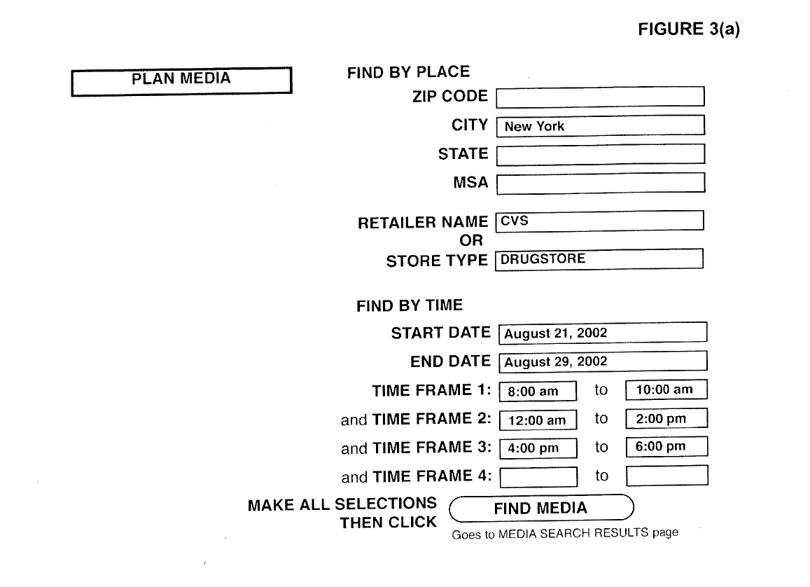

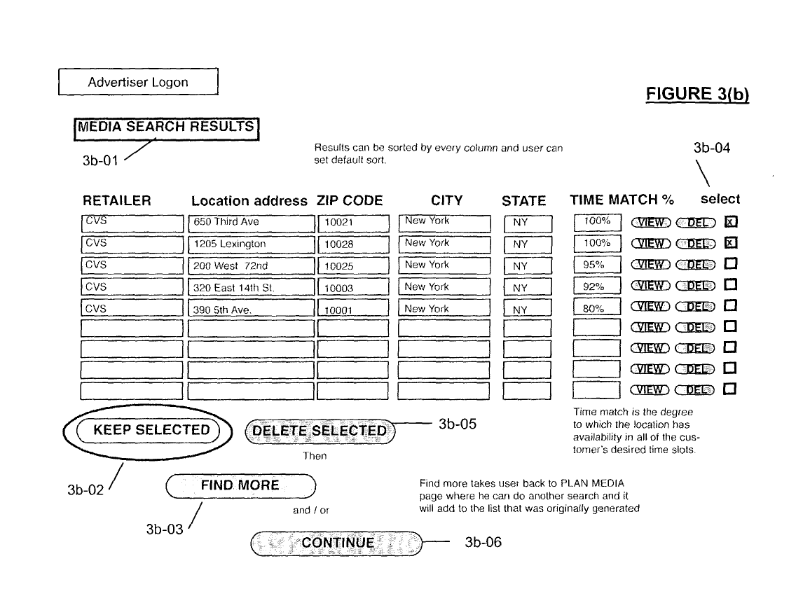

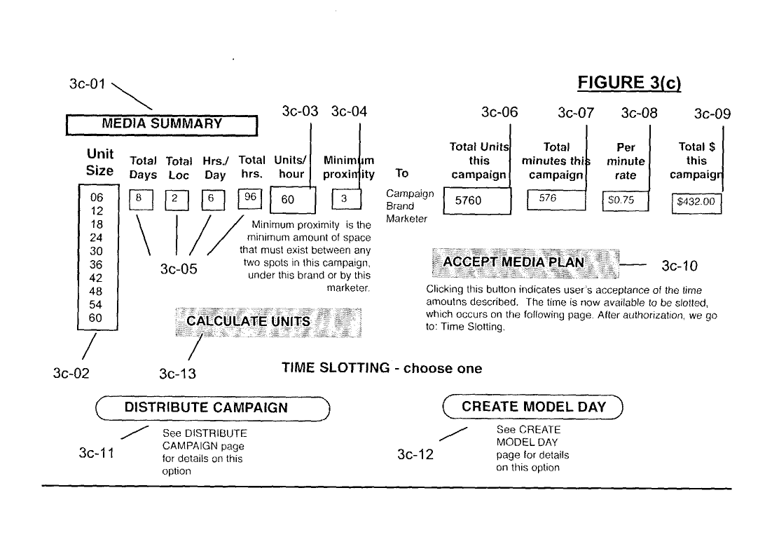

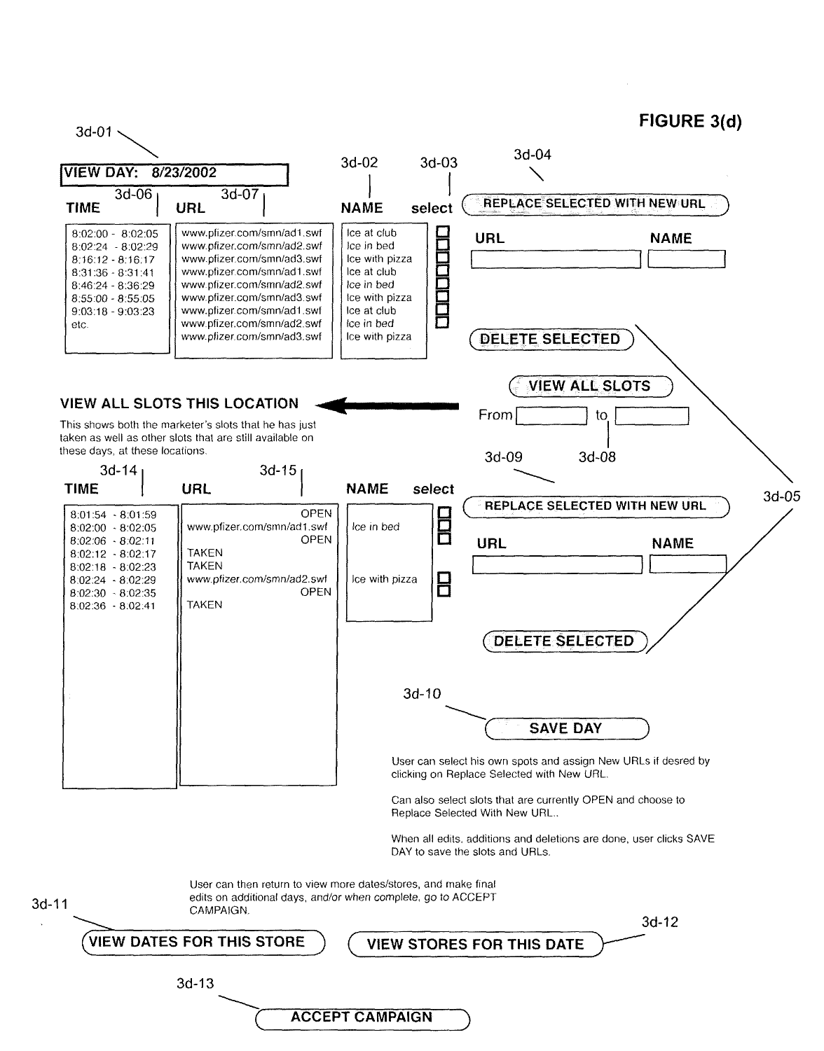

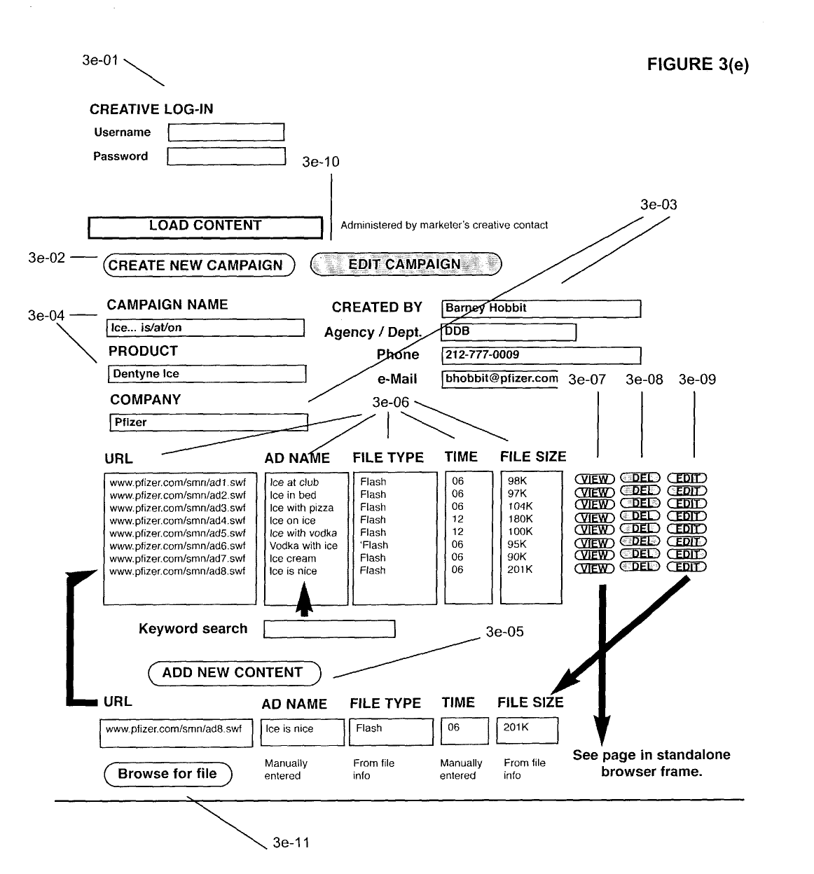

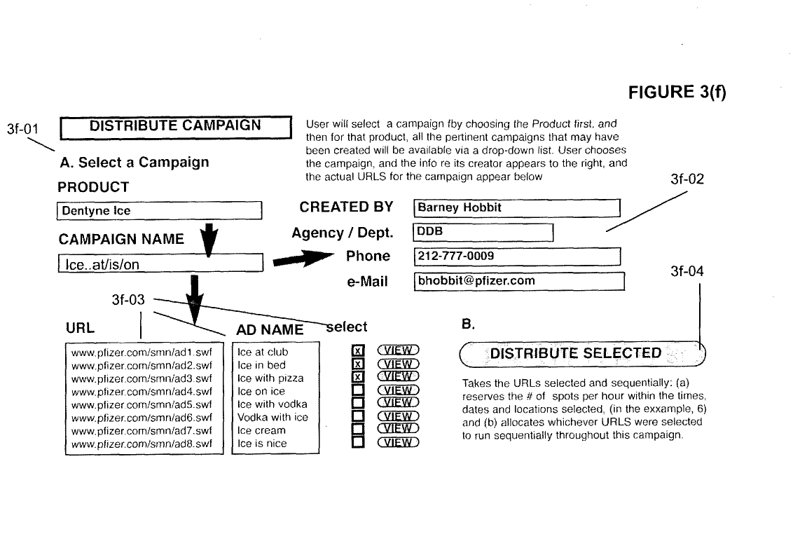

Referring now to FIG. 3, a flowchart is shown for the process that is used in establishing an advertising campaign for an authorized advertiser. An advertiser becomes authorized by undergoing an evaluation by a human representative of the system operator, and is evaluated for credit worthiness, is required to supply key contact personnel, and in step 3-21, signs a written agreement at agreeing to adhere to the terms and conditions of the system operator. Part of this agreement requires advertiser to provide a “default URL” displaying a simple, static web page that will be utilized as “placeholder content” to hold ad space that is reserved in advance, or to fill in time slots that the advertiser may have neglected to assign proper content to. This is required as part of the information registration process. Upon approval, the advertiser is assigned a username and password by the system operator's human representative. The advertiser logs on to the system at step 3-22. The system permits the user to access several areas of functionality from this point. In step 3-23, all of advertiser's relevant information including its negotiated cost per minute rate, is entered into the system's administrative database by the system operator. Advertiser does not have access to the administrative database and cannot view, edit or delete its contents without express permission from the system operator.

The primary area of activity outlined in FIG. 3, is Creation of the Media Plan 3-01. To this end, the system asks at step 3-02 for the advertiser to select the venues and time frames desired. The advertiser enters venue selection criteria in step 3-02.

For an example of a more detailed outline of the options that are provided, attention is now directed to 3-02 and FIG. 3(a). As illustrated, the first group of fields are designated as “FIND BY PLACE” and allow for searching by Zip Code, City, State or MSA (Major Statistical Area i.e. New York Metropolitan Area) which may encompass more than one city or state. This is followed by the ability to choose a particular venue by name, such as “CVS” or an entire category of retailer, such as “Drugstore”. Following this is the grouping of fields designated as “FIND BY TIME” providing parameters of Start and End date and different time periods within the average broadcast day that can be selected. To successfully proceed through the selection process, the advertiser is required to enter at least a start and end date, and may search based on those criteria only, or may narrow the search as much as desired by entering criteria in each of the aforementioned fields. After making the desired choices, the “FIND MEDIA” button is touched to move to the next screen, where the venues that meet the selection criteria are listed.

Referring back to step 3-02 of FIG. 3, if desired, after performing the search of basic criteria in 3-02, the advertiser can narrow the search parameters further by proceeding to step 3-03 in order to select by other qualitative criteria such as traffic levels, demographic makeup of the venue etc. Or, advertiser may go directly to 3-04. When complete with criteria selection, either after 3-03 or directly after 3-02, and the advertiser has clicked on the FIND MEDIA button the search results are displayed at step 3-04. For greater detail on how these results are displayed, refer to FIG. 3(b). The table shown under the heading, 3b-01 entitled “MEDIA SEARCH RESULTS” displays a sample list of venues that resulted from the search. By clicking on “KEEP SELECTED”, 3b-02, advertiser can go back and add to the list by doing another search by clicking on 3b-03 ‘FIND MORE” resulting in action 3-19, which sends the advertiser back to step 3-02. Alternatively, advertiser can trim the list presented in 3-04 and delete from it by checking the selection boxes 3b-04 and then clicking on ‘DELETE SELECTED”, 3b-05.

Once this list of viable candidates—venues that have available time in the parameters set forth in the search selection—has been finalized, and the advertiser is satisfied with 3-04, the advertiser clicks 3b-06 “CONTINUE”, which takes him to 3-06 of FIG. 3, requiring that advertiser specify desired unit size, frequency, proximity. For greater detail on what occurs in 3-06, refer to FIG. 3(c).

Under 3c-01, entitled “MEDIA SUMMARY,” advertiser must then indicate the specifics of the media plan it wants to implement. These specifics include:3c-02, Unit size, which as stated earlier can be any unit of time divisible by 6 seconds, between 6 and 60 seconds, 3c-03, Units/hour or how many advertising units per hour it wants to reserve, 3c-04, Minimum proximity, allowing the advertiser to stipulate that its ad units cannot be closer than x units to each other. For example, if the advertiser stipulates a minimum proximity of 3 units and chooses an interval and ad unit of 12 seconds, and a frequency of 20 per hour, the system will attempt to reserve twenty 12 second advertisements every hour of the schedule that has been stipulated by the search criteria, and that none of these 12 second advertisements will run with less than 36 seconds—in this scenario, the equivalent of 3 units (3×12 seconds)—between them. The other elements shown in the MEDIA SUMMARY, 3c-05, Total Days, Total Locations, Hrs/Day and Total Hrs. are all automatically drawn from the database of venue information, desired and displayed in 3-04, MEDIA SEARCH RESULTS. Turning again back to FIG. 3, in step 3-07, the advertiser touches the 3C-13, “CALCULATE UNITS” button. Then the system multiplies all the elements presented and entered in 3c-01 to derive 3c-06, the total number of Units this campaign will consume. This is divided by the multiple that combined with the unit size selected, results in one minute. For example, in the case of a six second unit, the multiple would be 10. Dividing 3c-06 by this multiple yields, 3c-07, the total number of minutes that the designated plan will consume. The system automatically retrieves advertiser's contracted cost per minute rate at 3c-08 from 3-25, the administrative database, and produces the cost that the given media plan will total at 3c-09. If this is acceptable at 3-23 of FIG. 3, the advertiser clicks on the “ACCEPT MEDIA PLAN” button 3c-10, and the system processes the order. Once this is done, the advertiser, has effectively “purchased” the time, as the time slots are removed from free inventory and are no longer available for other advertisers. The cash value of the time purchased is automatically recorded and an invoice is generated against the advertiser's account.

At this point, 3-08, advertiser has 2 options, it can save the media plan and STOP, at 3-20 (and resume later going straight from 3-22 Logon, to 3-15 Edit existing plan), or advertiser can Select Campaign at 3-09. Select Campaign 3-09 is the second step of the ad placement process, in which the advertiser assigns the content to the media plan created and will be discuss in more detail below.

An alternative approach illustrated in to FIG. 3, at step 3-04, provides an option that the advertiser may choose with regard to the preferred method of allocating the media time desired. The prior described methodology involved choosing a found set of venues, establishing general parameters regarding size of unit, proximity of units, times of day and other qualitative metrics if desired, and then distributing in as even a fashion possible, given available inventory and slot allocations, across the found venues and time spans. Alternatively, an advertiser can, after achieving the found set of venues that correspond to the other search criteria, 3-05, view time inventory that the system has allocated, for each venue. For a more detailed outline of this process, refer to FIG. 3(d). The system permits the advertiser to drill down to the 3d-01 Day, or the 3d-06 hour, minute and seconds, in which its proposed ad plan will run. Prior to step 3-08, when the media plan is accepted and purchased, these allocations are temporary and can be redone without any cost. At step 3-06, the only data that would appear would be the time frames in 3d-06, the data field referenced by 3d-07 would be blank. If the advertiser goes into 3d-01, VIEW DAY mode at step 3-08, the data field referenced 3d-07 would be filled with the advertiser's default URL; the system will at that point allow editing of URL information but will not allow for the retraction of the actual time slots as these have been purchased and taken off the market. If the advertiser goes into 3d-01, VIEW DAY mode after 3-11, the data in 3d-07 would be filled with the advertiser's URLs chosen specifically for the given campaign that had been allocated to these slots, as per the current illustration. Advertiser may choose to edit the content of these slots on a one-by-one basis by utilizing 3d-04, the “REPLACE SELECTED WITH NEW URL” function. Accordingly URLs that were loaded can just be deleted, 3d-05, in which case the default URL will automatically be re-assigned to the slot until new content is re-loaded. This VIEW DAY function also allows the advertiser to view ALL slots within a given time frame at 3d-08. In this mode, every six second interval is displayed in the left TIME field, 3d-14, and the URL field, 3d-15, lists 3 types of information: slots that are not yet reserved by anyone—OPEN; slots that are reserved by an entity other than advertiser—TAKEN; slots that are reserved by advertiser—www.advertisers-campaignurl1.com, www.advertisers-campaignurl2.com etc. Advertiser can tailor presence in any given day, using these tools. When satisfied with day's layout, can SAVE DAY at 3d-10. Also accessible from this module is 3d-11, the ability to view all dates for which the advertiser has presence within the given venue, or to 3d-12 the ability to view all venues in which the advertiser has presence during a given date. When all is acceptable, advertiser clicks on 3d-13, ACCEPT CAMPAIGN.

Referring back to FIG. 3, it is also illustrated that at step 3-08, where the media plan is accepted and purchased, any slots reserved in that plan which are not filled by the process described in 3-09, 3-10 and 3-11, shall be identified as vacant at 3-16, and will be filled with the default URL at 3-17 as a placeholder until such time that advertiser re-enters the system and goes to 3-15 to Edit the existing plan.

In step 3-07, the system calculates the total time and total cost of the advertising campaign and in step 3-23 compares the cost to available funds or credit provided by the advertiser on a daily, weekly or monthly basis. If the credit is insufficient, additional funds or credit is requested and the system rejects the purchase and cycles back to step 3-02, prompting advertiser to input new Venue and Time selection criteria so that the resulting buy will not exceed available funds or credit. If there is sufficient credit, the advertiser is taken to step 3-08 to approve or disapprove the cost. If approved, the schedule of venues and time slots therein is saved as a “media plan”. If the advertiser does not approve at step 3-08, the system cycles advertiser back at step 3-24 to step 3-02 prompting to re-enter venue and time selection parameters. If the advertiser does not wish to revise, the system stops with a sign-off message to the advertiser (not shown).

In FIG. 3, step 3-26 describes the actions of the advertiser's production operator, in preparing the content to be properly found and referenced by the system. This process is illustrated in greater detail in FIG. 3(e). The example illustrates the process by which content that has been created for running in the advertising campaign is uploaded by advertiser's content production operator, to be made available to the individual who is placing the media plan. Advertiser's content production operator is provided a password that only allows access to this content upload module. Username and password is entered at 3e-01 to enter the system. Information from the production operator's personnel record is also automatically entered into the reference fields shown at 3e-03. Step 3e-02, “CREATE NEW CAMPAIGN” is the default setting for this module. A CAMPAIGN is a meta-term referencing one or more specific ads—individual URLs or statif files—that relate to the campaign them. When creating a new campaign the production operator proceeds to step 3e-04, and enters the name of the product and the campaign name that the ad about to be selected will be referenced under. Operator then proceeds to step 3e-05, to choose a URL or file that is desired for the specific ad that is to be included as part of the campaign. Operator touches the button 3e-11, to access the server 1-01, on which the content is stored, allowing him to locate the specific file. Once selected, the system automatically fills in the URL (or file name), the TILE TYPE and the FILE SIZE. The production operator must assign the AD NAME and TIME that the content will play by entering this data into the corresponding fields. When done, the production operator clicks on the “ADD NEW CONTENT” button, the new ad, it's URL and its relevant information is loaded to the display table, 3e-06. This table displays the URL address, the AD NAME and TIME designated by the operator and the FILE TYPE, and FILE SIZE from the fields in which these data were originally displayed, in 3e-05. Once a URL is in this table it can be, 3e-07, viewed, 3e-08 deleted, or 3e-09 edited. Accordingly, If the operator wants to edit an existing campaign, the CAMPAIGN and PRODUCT NAME are entered at step 3e-04 and the 3e-10 EDIT CAMPAIGN is clicked to retrieve the desired campaign.

Referring now to step 3-09 and 3-10 of FIG. 3, these steps assume that appropriate URLs required for the media plan that has just been purchased, have been created and loaded into the system by the production operator in 3-26, and are now waiting, ready to be assigned. In step 3-09 the campaign is identified and in step 3-10 the specific URLs that are desired are chosen. For more detail on the process referenced in 3-09 and 3-10, refer to FIG. 3(f). At 3f-01 the advertiser clicks on the PRODUCT field. This pulls up a list of product names for which this advertiser's production staff has created and stored campaigns in the system. Advertiser selects one product, and this in turn pulls up a list of campaign names in the CAMPAIGN field that advertiser's production staff has created and stored, relating to the selected product. Advertiser then clicks on the name of the campaign desired, effectively selecting that campaign. This in turn prompts the system to load, at 3f-03, the basic information relating to all the content that has been created for each ad that comprises that campaign. This information includes the URL and the specific name of the advertisement. At 3f-03, the advertiser checks off the “select” boxes to indicate which of the URLs is desired for running in the chosen media plan. When these choices have been made, at 3f-04, the DISTRIBUTE SELECTED button is clicked and the URLs are wedded to their designated time slots.

If multiple URLs are selected, they will play in sequence and then loop back until done. If the campaign was the aforementioned 12 second spot, with 36 second intervals, the first spot of the day, will play the first URL in the list, the next will play the second, the next will play the third, and the fourth spot will loop back to play the first URL again and so on.

After the campaign has been distributed to the media plan, the advertiser has the option to go back into the system at any time prior to the date of the first time slot in the plan and prior to any blackout period that the system operator may set prior to this date (i.e. no changes within 72 hours of the display date), and change the URLs that are allocated to the plan. Advertiser selects 3-15, “EDIT MEDIA PLAN” and then goes back into the prior described sequence of choosing URLs for content that will be distributed throughout the plan.

Note that the URLs for the content that appears at the designated times, can be based on any server to which the system operator has been given access. This access can be accomplished internally, communicating with a server that resides within the system operator's or a server that is owned and operated by the Advertiser. This access can be to a variety of possible networks including: Local Area Network, or over a proprietary Wide Area Network, over a wireless network, or over the public internet.

While it is anticipated that the step of selecting advertising venues and times will usually be done by the advertiser, the present system also contemplates that this process may be done by the system operator who has been given the advertiser's criteria, including cost allowances (not shown).

Referring back again to FIG. 3, it is shown that after the advertisement is submitted in step 3-11, an inspection of the content of the advertisement is conducted by the system operator in step 3-12. Such an inspection is done of the advertisement to avoid inclusion of such objectionable content as profanity, obscenity, offensive language, libelous statements, statements against the interest of the host venue, etc. If the advertisement is approved in step 3-12, the advertisement is cleared for downloading by the display units, saved to server 1-01 (FIG. 1) and the system stops with a sign-off message to the advertiser. If the advertisement is not approved in step 3-12, a rejection is issued in step 3-13, and the advertiser may revise the advertisement in step 3-15, and resubmit in step 3-09 to be reinspected in step 3-12. The system is designed to insure that no new or revised advertisement is placed into the server or displayed publicly without prior approval of its content. It is also to be understood that this approval process is not anticipated to happen instantaneously, but that instead the system operator's content review staff will review all advertisements, which process will take time. Accordingly, in the real world, steps 3-11, 3-12, 3-13, 3-14 (and back again) will actually result in the system providing a sign-off notice to the submitting advertiser immediately after step 3-11, advising the advertiser that the advertisement will now be submitted to the system operator's content review team, and that if the advertiser has questions or wants to know the status of the review, it can inquire at www.advenue.com (fictitious website for purpose of example) and enter the transaction reference number to obtain the status.

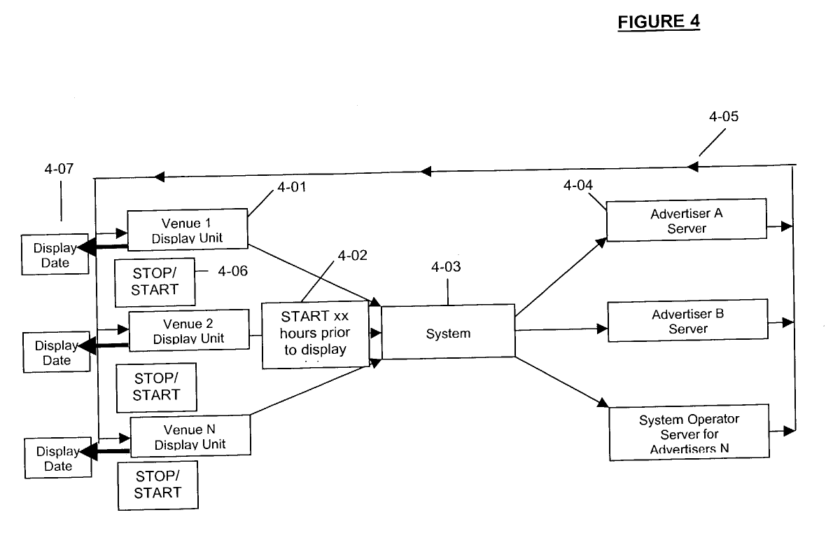

Referring now to FIG. 4, the flowchart shows the cycle of communications that occurs between 4-01, the venues display units, and the rest of the network. This cycle begins and ends at the Venue Display Unit. The objective of this cycle is to retrieve and broadcast the correct content at the correct time in the correct place. Content is STORED in 4-04, servers that hold campaign files, ADMINISTERED, via 4-03, the System, and DISPLAYED on 4-01, the Venue Display Units. Every night or day, each venue 4-01, on the network activates step 4-02, and automatically communicates with the System, via the live internet link. The System directs each venue display unit to pull the appropriate content off of the appropriate server(s) in 4-04. This content is 4-05, sent to the venue display and copied onto the venue display unit. The task STOPS. The system then STARTS again and completes its cycle at 4-07, the Display Date, at which time the previously loaded content plays out on the intended output device, at the scheduled time, in the scheduled location.

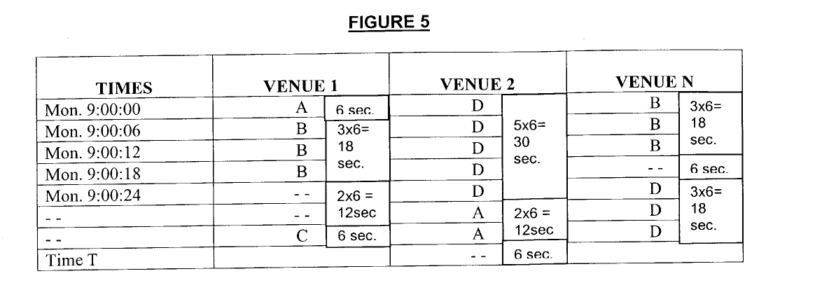

Referring now to FIG. 5, an abbreviated, simplified chart shows a sampling of venues and times for displaying advertisements. The time values indicated in the chart reflect 6 second intervals for displaying advertisements. That is, an advertisement may be displayed for six seconds only, for two or more consecutive six second intervals or for a series of connected or disconnected six second intervals or multiples thereof. In the preferred embodiment, advertisements are in substantially exact six second increments. The chart indicates a time sequence extending from Monday, 9:00 to Time “T” with a series of venues 1, 2 . . . N listed across the top. Advertisements A, B, C and D have been inserted in a hypothetical distribution such that in venue 1 advertisement A is to be displayed for six seconds, advertisement B is displayed for 18 seconds, there is a gap of 12 seconds, and advertisement C is displayed for six seconds. Advertisements A, B, C and D may or may not originate at the same advertiser. Similar arrangements are shown in relation to venue 2 and venue 3 with advertisements A, B and D. Whatever open time periods remain in the inventory are distributed in whatever manner deemed appropriate by the system operator, according to the executed agreement. The previously referenced default URL is required for every entity that reserves time on the system, for example “Your ad can be shown here. Contact us at (email address, etc.) for more information,” is inserted into unused times for various venues. Thus, it is understood that the venue provider must have a prepared filler advertisement available at the time the venue is activated to utilize open time periods, as does any registered advertiser, as does the system operator itself. The system is configured so that a chart of all venues and available display times or a chart of times during which a specific venue is unoccupied can be displayed to an advertiser as discussed above for the advertiser to make selections.

The information comprising the venue and time chart is accessed by the display unit corresponding to the demised venue. The computer within the display unit is programmed to automatically access the dynamic, live internet connection at a specific time every day for the purpose of accessing the schedule of content that has been designated to run in every six second interval in the forthcoming day or a day further in the future. The preferred embodiment allows for the computer within the display unit to perform this task 36 hours in advance of the time when the content will be scheduled to run. According to this embodiment, the computer within the display unit will continually be storing 2 days worth of scheduled content. However, the system can be programmed to communicate with the system at any interval prior to the scheduled display time of the allocated content. On each day in which the system will be live, the display unit will respond to a software program that turns the electrical power on for the imaging device in the display unit, such as a projector or a monitor, and proceeds to display the scheduled content that was previously retrieved from the server and saved onto the computer within the display unit.

According to the electronic display advertising system described herein, a network connection, the required hardware, electrical power, local signage permits if needed, and appropriate service and insurance coverage must be provided by either the venue owner or the system operator or both. The system operator specifies and approves the display equipment to ensure uniform quality throughout the system. The advertiser is responsible for generating and submitting advertisements and for paying a fee for each time period in which an advertisement is displayed at a location. The system operator is responsible for training venue entity personnel, verifying the initial operation of the venue equipment, obtaining advertisers, inspecting advertising content and invoicing for display times. The venue-providing entity receives a portion of the advertising fees for that venue and the system operator receives the balance. In a first embodiment, display fees are constant for all venues and all times. In a second embodiment, display fees differ to reflect the fact that different venues and times are more desired than others. In a third embodiment, displays fees are set according to historical viewer traffic at each venue. In a fourth embodiment, display fees are set according to total volume of time purchased in a single commitment. In a fifth embodiment, display fees are set according to the frequency by which time is purchased.

While the present invention is described with respect to specific embodiments thereof, it is recognized that various modifications and variations may be made without departing from the scope and spirit of the invention, which is more clearly and precisely defined by reference to the claims appended hereto.

What is claimed is:

1. A method for providing display advertising, comprising the steps of:
(a) connecting a server computer to a network;
(b) connecting an advertising generator to the network;
(c) providing a display device at an advertising venue;
(d) connecting the display device to the network;
(e) transmitting an advertisement from the advertising generator to the server computer;
(f) transmitting the advertisement from the server computer to the display device; and
(g) displaying the advertisement on the display device.
